(19) United States
(12) Patent Application Publication
(10) Pub. No.: US 2012/0072310 A1
(43) Pub. Date: Mar. 22, 2012

(54) Method and System for Online Interactive Selection of a Preferred Article

(76) Inventor: Alexios Ballas, Athens (GR)

(21) Appl. No.: 13/234,023

(22) Filed: Sep. 15, 2011

Related U.S. Application Data
(60) Provisional application No. 61/383,730, filed on Sep. 17, 2010.

(51) Int. Cl. G06Q 30/00

(52) U.S. Cl. 705/26.61

(57) ABSTRACT

A method and system for selecting and purchasing an item online based on the purchaser's preference and taste are disclosed. The system and method interactively and progressively leads the purchaser to an item that conforms to his preference and taste by a series of interactive steps wherein the purchaser is presented with items and has the option of indicating his preference for one item or his lack of interest in all items until he makes his decision to select his preferred item or to abandon the search. In each progressive step the prospective purchaser is presented with items based on his prior choices.

### RELATED PRIORITY DATE APPLICATION

This application claims the benefit under 35 U.S.C. 119(e) of the U.S. provisional application No. 61/383,730 filed on Sep. 17, 2010.

### TECHNICAL FIELD OF THE INVENTION

The present invention relates to the field of electronic commerce and, more particularly, to a system and method for selecting and purchasing an item online based on the purchaser's preference and taste. Still more particularly, the present invention discloses a system and method for interactively and progressively leading the purchaser to an item that conforms to his preference and taste by a series of interactive steps wherein the purchaser is presented with items and has the option of indicating his preference for one item or his lack of interest in all items until he makes his decision to select his preferred item or to abandon the search. In each progressive step the prospective purchaser is presented with items based on his prior choices, the choices of people belonging to a similar group of purchasers determined by age, geographic location and the like or utilizing other suggestion criteria determined by an algorithm based on available items from a large number of vendors.

### BACKGROUND OF THE INVENTION

Traditionally, consumers looking for an item to purchase or to check the latest trends in fashion and products visited the stores and browsed through store exhibits, showcases and the like to find the preferred item. In the case of many items and especially fashion items such as clothing, shoes, purses or the like, window shopping is a common and pleasurable habit and practice amongst the consumers, especially females. Consumers spend a substantial amount of time going to stores selling those items to look at the windows or other displays thereof to check the latest fashions, get a feel of the latest trends or decide on their next purchase.

The large expansion of electronic commerce in the last few years has created the practice of virtual window shopping wherein consumers visit electronic stores online and other online media such as fashion magazines using a computer and the INTERNET to investigate the latest fashions, trends and offerings and to make purchasing decisions. Because of the ease of creating electronic stores and the immense global power and presence of the INTERNET, the number of electronic stores and other media offering every imaginable item is very large. As a result, a potential purchaser has difficulty in finding the product that best matches his taste or preference and needs to spend a substantial amount of time to find the best item out of the many available.

In order to reduce the difficulty created by the unlimited sources in the INTERNET, several online item presentations have been created to assist a consumer in making his decision. They are generally grouped in two categories, namely, window shopping and thumbnails. In the window shopping approach which has been adopted by most large online retailers a display approach attempts to simulate the offline window shopping experience using three to four large images of the item together with a next button to navigate to more images of the item. Although this is an approach that can be used to look through many products of an item category and give the consumer an idea of what is offered by a particular electronic store, it is time consuming, it is a mere replication of the offline window shopping and does not take advantage of the interactivity and data collection properties of the web to give the consumer the opportunity to have an input of his taste and to have access to a continuous stream of suggested items from thousands of items available online.

In the thumbnail approach, electronic retailers utilize systems that allow for user rating and recommendations that are based on collected data and present their content in a thumbnail and zoom-in manner making navigation dull and cumbersome. Moreover, the item rating and data collection is done using a five star rating or a “favorites” feature making user input unlikely as it lacks an incentive for the user to provide such input.

According to the present invention, a method and a system is disclosed that enables a customer connecting to the web to have access to a vast number of products collected from various sources in one place and to make a selection conforming to his taste quickly through an interactive process that is pleasant and entertaining and which gives the customer the opportunity to input his own taste in the selection process.

These and other advantages of the present invention will become apparent from the following description and drawings.

### SUMMARY OF THE INVENTION

According to the present invention, a system and a method are disclosed for selecting and purchasing an item online based on a purchaser's preference and taste. The purchaser is presented with items interactively and progressively and has the option of indicating his preference for one item or his lack of interest in all items until he makes his decision to select his preferred item or to abandon the search. In each progressive step, the items presented are based on the purchaser's prior choices and other suggestion criteria.

A user connects to the INTERNET and is presented with a list of categories of products with a first option to identify the category he is interested in or a second option to view all products. If he elects the first option, he is directed to the next page where he is presented with three products of the particular product category and has five options to choose from, namely, liking one of the three products presented, lack of interest in any of the three products or buying one of the three products. If the user elects to buy one of the products, he is directed to another page which is typically associated with the seller of the particular product wherein the purchase is consummated. If the user elects one of the other options, he is directed to the next page wherein he is again presented with three new products of the product category with five options that are similar to the five options presented in the previous page and the process is repeated until the user elects to purchase a particular product or abandons the search.

If the user is not interested in a particular category, he may elect to view all products and is directed to the next page where he is presented with three different products which may belong to different categories. He has five options to choose from, namely, liking one of the three products presented, lack of interest in any of the three or buying one of the three. If the user elects to buy one of the products, he is directed to another page which is typically associated with the seller of the particular product wherein the purchase is consummated. If the user elects one of the other options, he is directed to the next page wherein he is again presented with three new products with five options that are similar to the five options presented in the previous page and the process is repeated until the user elects to purchase a particular product or abandons the search.

The user's indications of his liking or lack of interest in products are stored in a database for consideration in the determination of what three new products of the product category or products are presented to the user in the pages that follow or in the future when the user returns to the portal. Other factors may also be taken into consideration in the presentation of the three new products or type of products as the search for the desirable product advances such as choices of products within the system by other users who have common traits with the user, characteristics and traits of the product such as brand, color, etc. and the like. An algorithm takes into consideration those choices and factors to make the selection of the next three products of the product category or types of products presented to the user as he progresses is his search. Thus, the selection process is refined and the user is presented progressively with products conforming to his taste so that he select the desirable item from a large number of products.

### BRIEF DESCRIPTION OF THE DRAWINGS

For a detailed description of the invention, reference will be made to the accompanying drawing wherein:

FIG. 1A is a block diagram depicting the method and the system disclosed by the present invention;

FIG. 1B is a block diagram depicting the method and the system disclosed by the present invention;

FIG. 2 is a schematic of a computer screen depicting the web site of an online portal as used in accordance with the present invention;

FIG. 3 is a schematic of a computer screen depicting the web site of an online portal as used in accordance with the present invention;

FIG. 4 is a schematic of a computer screen depicting the web site of an online portal as used in accordance with the present invention; and

FIG. 5 is a schematic of a computer screen depicting the web site of an online portal as used in accordance with the present invention.

### DETAILED DESCRIPTION OF THE PREFERRED EMBODIMENTS

According to the present invention, a system and method for selecting and purchasing an item online based on a purchaser's preference and taste interactively and progressively leads the purchaser to an item that conforms to his preference and taste. The system and method utilizes a series of interactive steps wherein the purchaser is presented with items and has the option of indicating his preference for one item or his lack of interest in all items until he makes his decision to select his preferred item or to abandon the search. In each progressive step the prospective purchaser is presented with items based on his prior choices, the choices of people belonging to a similar group of purchasers determined by age, geographic location, and the like or utilizing other suggestion criteria determined by an algorithm based on available items from a large number of vendors and their interconnections. The algorithm takes into account the user's prior choices and, preferably other factors such as the choices of people belonging to a similar group of purchasers determined by age, geographic location, and the like, the characteristics and traits of the product like brand, color, etc. or other suggestion criteria. As the user utilizes the method and the system, his choices are taken into consideration to build a profile of his taste and preferences that is used to suggest items to him.

According to the invention, a user connects to the INTERNET via a computer or similar device and enters a website wherein he remains as a guest or logs on with an account. The user is presented with an extensive list of categories of products such as trousers, sunglasses, women's apparel, bags, etc. The user has the option identify the category he is interested in or, if he is not interested in a particular category, to view all products.

If the user is interested in a product category and identifies the category, he is directed to the next page where he is presented with three products for the particular product category. The user has five options to choose from. He can choose only one of the five options The first, second and third options are to indicate his liking of the first, second or third product of the product category, respectively, by clicking on one of them. His fourth option is to indicate that he does not have an interest in any of the three products. The user's selection of the fourth option may be manifested by the user's clicking on an appropriate button. Alternatively, the user's selection of the fourth option may be manifested by a scroll down of the mouse, by moving the mouse to a certain position or by doing nothing. If the latter case wherein the fourth option is manifested by doing nothing, an auto refresh feature is provided so that, after several seconds, the page is refreshed and three new products are presented to the user. His fifth option is to indicate his intend to buy one of the three products of the product category by clicking on an appropriate button. If the user decides to buy one of the products of the product category, he is directed to another page which is typically associated with the seller of the particular product wherein the purchase is consummated by well known electronic commerce techniques. If the user elects one of the first four options, namely liking the most one of the three products of the product category or not having an interest in any of the three products, he is directed to the next page wherein he is again presented with three new products of the product category with five options that are similar to the five options presented in the previous page, namely, first, second and third options to indicate his liking of the first, second or third new product of the product category, respectively, a fourth option is to indicate that he has no interest in any of the three new products and a fifth option to indicate his intend to buy one of the three new products of the product category. Like in the previous page, the user can exercise one of the five options, by indicating his most liking of one of the three new products of the product category, his lack of interest in any of the three or his intend to buy one of the three. Like in the previous page, if the user elects option five and decides to buy one of the three new products of the product category he is directed to another page where the purchase is consummated. If the user elects one of the first four options, he is directed to the next page wherein he is again presented with three new products of the product category with five options that are similar to the five options presented in the previous pages, namely, first, second and third options to indicate his most liking of the first, second or third new product of the product category, respectively, a fourth option is to indicate that he has no interest in any of the three new products and a fifth option to indicate his intend to buy one of the three new products of the product category. The process is repeated until the user finds the desired product or abandons the search. If the user is a registered user and conducts this search through his account, the information of his likings and his lack of interest in some products is stored in his account to build a profile for the user for future consideration and as a guide in proposing selections to the user in his future searches for the desired product. The information of his likings and his lack of interest in products may also be retained for future use to an unregistered user through cookies as long as such user uses the same computer for future transactions and does not delete the cookies.

As stated above, if the user is not interested in a particular category, he may elect to view all products. If that is the case, he is directed to the next page where he is presented with three different products which may belong to different categories. Like in the process previously described in connection with the selection process of a product within the same product category, the user has five options to choose from. He can choose only one of the five options The first, second and third options are to indicate his liking of the first, second or third products, respectively, by clicking on one of them. His fourth option is to indicate that he has no interest in any of the three products by clicking on an appropriate button. His fifth option is to indicate his intend to buy one of the three products by clicking on an appropriate button. If the user decides to buy one of the products, he is directed to another page which is typically associated with the seller of the particular product wherein the purchase is consummated by well known electronic commerce techniques. If the user elects one of the first four options, namely liking the most one of the three products or lack of interest in any of the three products, he is directed to the next page wherein he is again presented with three new products which may or may not be of the same category with five options that are similar to the five options presented in the previous page, namely, first, second and third options to indicate his liking of the first, second or third new product, respectively, a fourth option is to indicate that he has no interest in any of the three new products and a fifth option to indicate his intend to buy one of the three new products. Like in the previous page, the user can exercise one of the five options, by indicating his most liking of one of the three new products of the product category, his lack of interest in any of the three or his intend to buy one of the three. Like in the previous page, if the user elects option five and decides to buy one of the three products he is directed to another page where the purchase is consummated. If the user elects one of the first four options, he is directed to the next page wherein he is again presented with three new products which may or may not belong in the same category with five options that are similar to the five options presented in the previous pages, namely, first, second and third options to indicate his most liking of the first, second or third product, respectively, a fourth option is to indicate that he has no interest in any of the three products and a fifth option to indicate his intend to buy one of the three products. The process is repeated until the user finds the desired product or abandons the search. The information of his likings and his lack of interest in products is stored in his account for future consideration and as a guide in proposing selections to the user in his future searches for the desired product. The information of his likings and his lack of interest in products may also be retained for future use through cookies as long as such user uses the same computer for future transactions and does not delete the cookies.

According to the present invention, each time the user makes an indication of his liking or lack of interest in particular products of a product category or the product itself, such indication is stored in a database and is taken into consideration by the method and system of the present invention in the determination of what three new products of the product category or products are presented to the user in the pages that follow. Accordingly, when a user does not elect to purchase the product but elects one of the first four options and advances to the next page as described above, the three new products of the product category or types of products presented to him are not random but are based, among other things, on his choices that he made in the previous pages. Other factors taken into consideration in the presentation of the three new products or type of products as the search for the desirable product advances may include, but are not limited to, the users prior choices in prior visits to the site which are stored in a database associated with the user's established account or with the specific computer through the use of cookies, the user's age and other personal information and characteristics and demographic data, the choices of products within the system by other users who have common traits with the user such as age or the like and other factors that may be taken into consideration depending on the particular product. Those and other factors are taken into consideration by an algorithm which is used to make the selection of the next three products of the product category or types of products presented to the user as he progresses is his search of the product he desires to locate and purchase.

The use of the prior selections and the other data in the progressive presentation of choices provides for the refinement of the selection process wherein the user is presented progressively with products conforming to his taste so that he can easily and quickly select the desirable item from thousands or even millions of products that are available for viewing. This interactive process makes online shopping enjoyable, timely and economically efficient and results in a transaction that is based on the consumer's taste.

The products that are available for inspection and purchase are gathered and made available on an almost real time basis from a large number of sources such as electronic stores, online catalogues, manual input and other well known sources by well known techniques which may vary depending on the product and other factors. The number of products available is very large and suitable to satisfy every purchaser's taste and wallet and to make this shopping experience very satisfying.

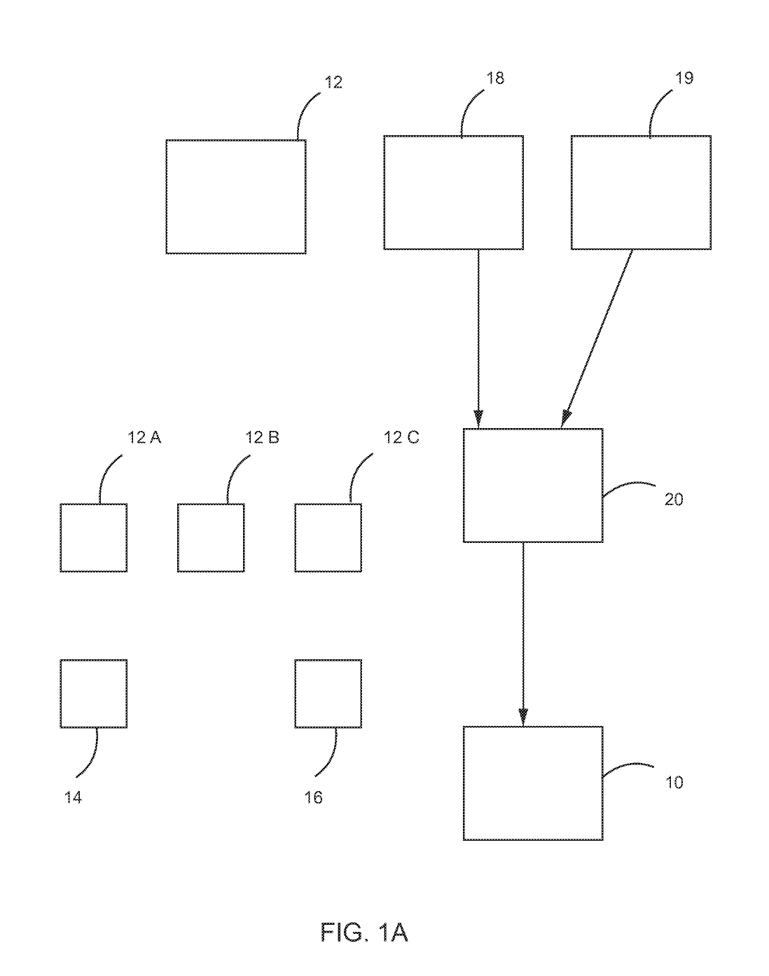

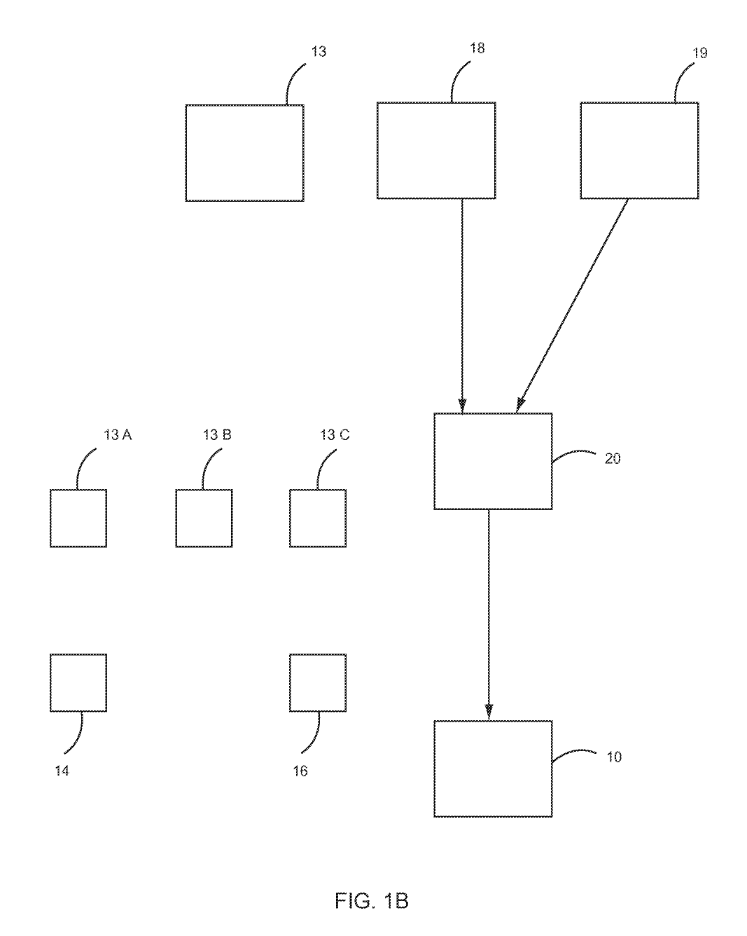

FIGS. 1A and 1B are general schematics depicting one embodiment of the method and system of the present invention. Referring to FIG. 1A, there is shown a database 10 containing the products that are available for inspection and purchase gathered and made available on an almost real time basis from a large number of sources described above. The user selects a general product category 12 from database 10 and, upon such selection, he is offered products 12A, 12B and 12C of product category 12 and has the option to indicate his liking of one of those products. He is also offered an option 14 to purchase one of the three products 12A, 12B or 12C. Further, he is offered an option 16 to indicate that he has no interest in any of products 12A, 12B or 12C. If he elects one of the options of liking one of products 12A, 12B or 12C or lack of interest in any of them the information is sent to a database 18 wherein the user's preferences and choices are stored. The information from database 18 together with other information relevant to the brand, color, categorization, shape or other characteristics of the product, the choices of users belonging to a similar group of purchasers determined by age, geographic location, and the like and other relevant information from a database 19 is processed by algorithm 20 to choose from database 10 three new products of product category 12 to replace products 12A, 12B and 12C and the process is repeated as described above until the user makes a purchase or abandons the process.

Referring to FIG. 1B, there is shown database 10 containing the products that are available for inspection and purchase gathered and made available on an almost real time basis from a large number of sources described above. The user selects all products 13 from database 10 and, upon such selection, he is offered products 13A, 13B and 13C and has the option to indicate his liking of one of those products. He is also offered an option 14 to purchase one of the three products 13A, 13B or 13C. Further, he is offered an option 16 to indicate that he has no interest in any of products 13A, 13B or 13C. If he elects one of the options of liking one of products 13A, 13B or 13C or lack of interest in any of them the information is sent to a database 18 wherein the user's preferences and choices are stored. The information from database 18 together with other information relevant to the brand, color, categorization, shape or other characteristics of the product, the choices of users belonging to a similar group of purchasers determined by age, geographic location, and the like and other relevant information from a database 19 is processed by algorithm 20 to choose from database 10 three new products to replace products 13A, 13B and 13C and the process is repeated as described above until the user makes a purchase or abandons the process.

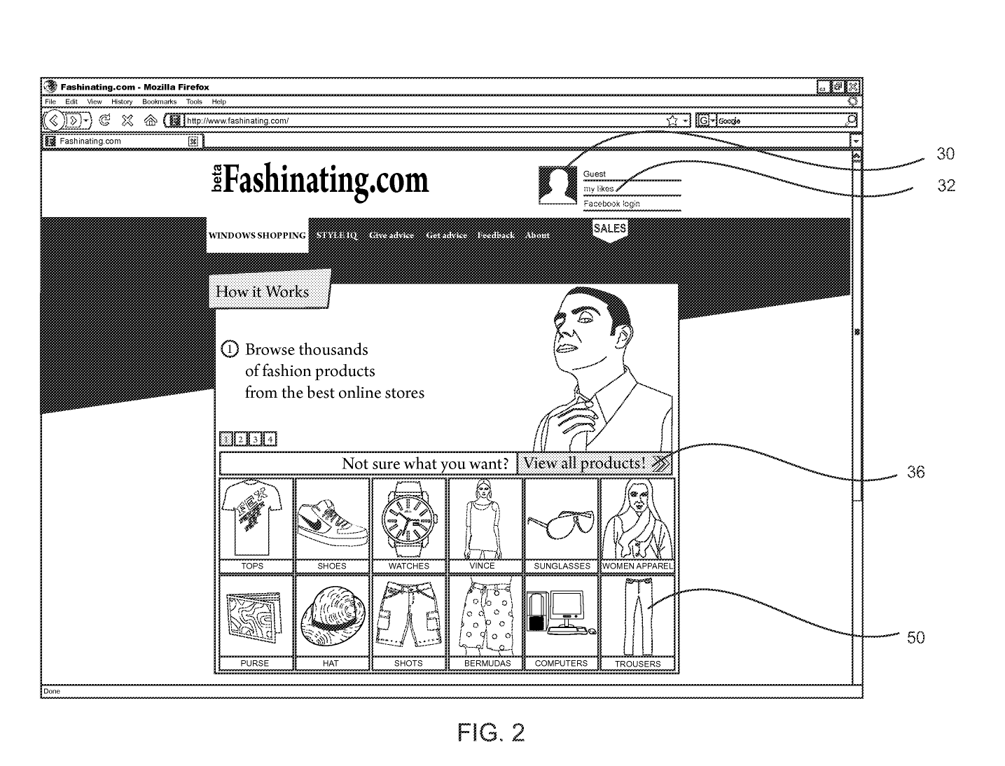

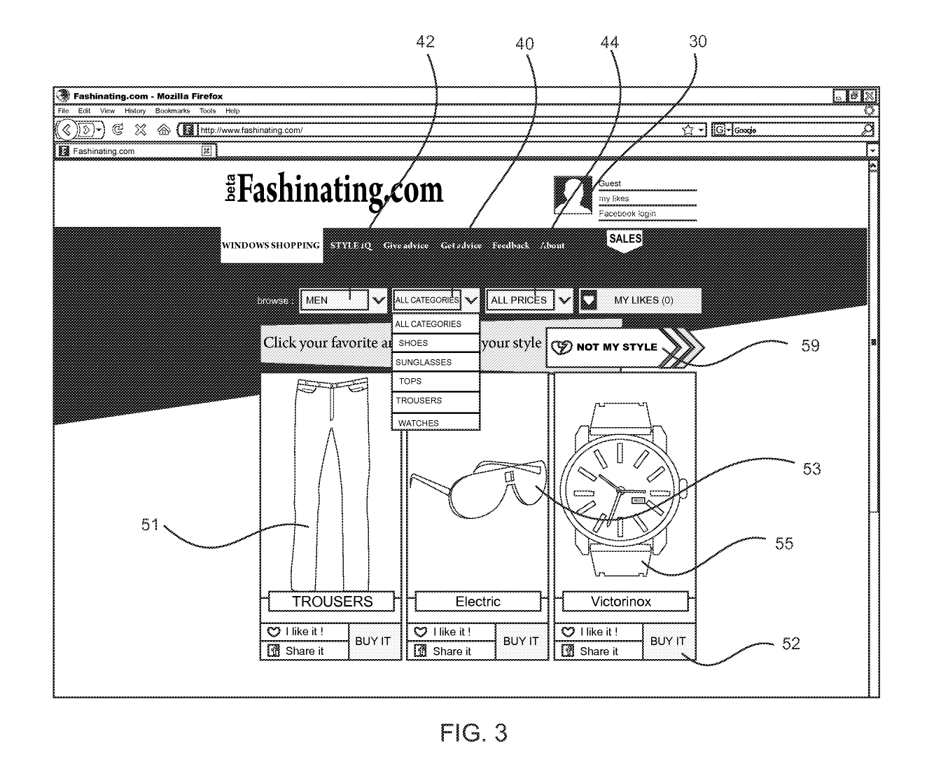

The present invention will now be described in connection with a typical utilization of the method and system by a customer with an online window shopping web site identified as www.fashinating.com, referred to herein as “Fashinating”. In accordance with the present invention, the customer connects to the Fashinating web site as a guest or logs in as a registered user. Referring now to FIG. 2 there is shown the computer screen image of Fashinating showing a user 30 being logged in the website with a connecting link 32 that links to a database that contains user 30's choices or likes from past visits to the web site. There is shown a connecting link 36 for user 30 to view all products offered in the website. If user 30 clicks on connecting link 36 he is directed to another web page shown in FIG. 3.

Referring now to FIG. 3, there is shown another page of Fashinating with user 30 logged in and showing a pull down menu 42 to pick the gender of the user of the item to be purchased or chosen, a pull down menu 40 showing all the categories of items being offered and a pull down menu 44 showing price ranges of the items. From that web page, user 30 can choose products based on his likings in accordance with the present invention.

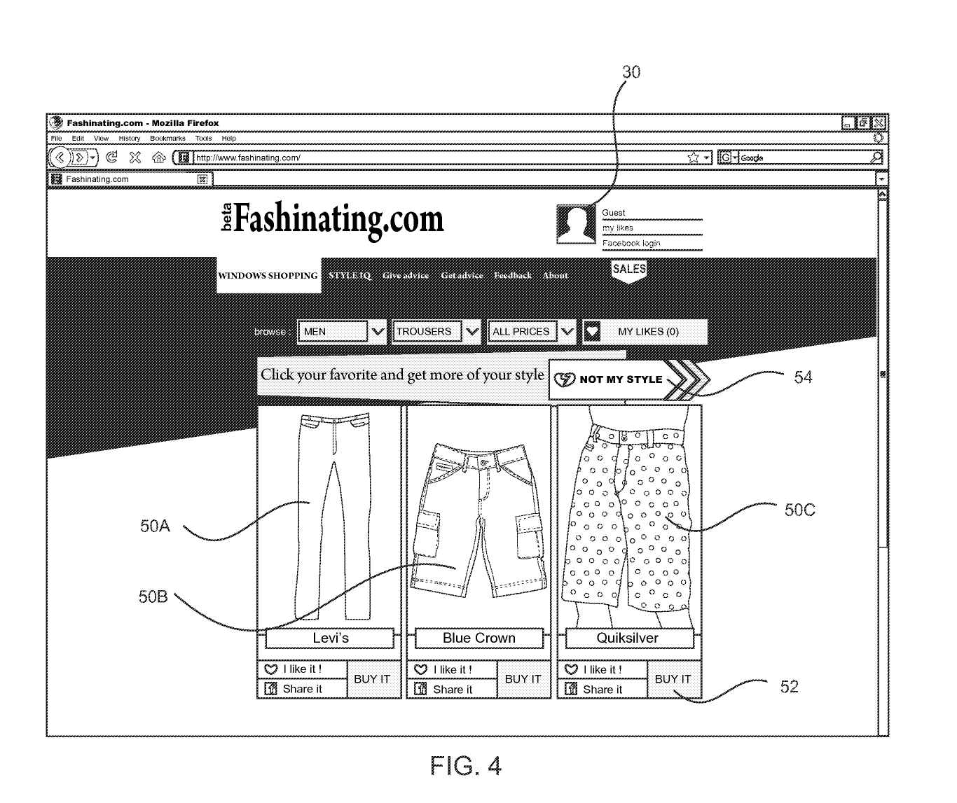

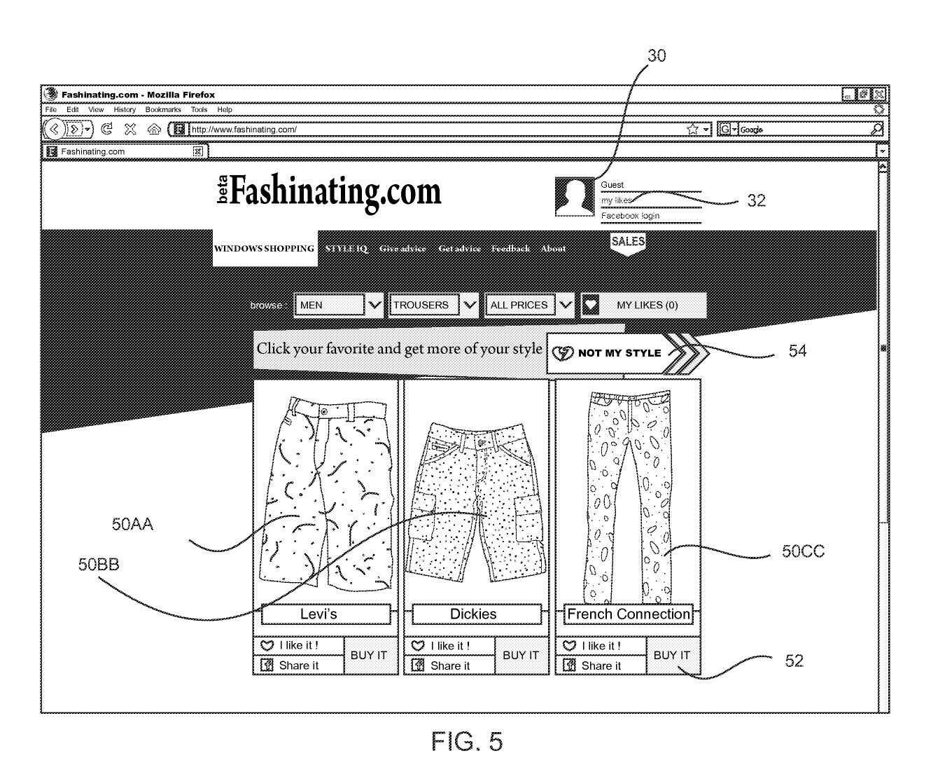

Referring back to FIG. 2, if user 30 does not wish to view all products by clicking on link 36, but wishes to select trousers, he clicks on link 50 for trousers and is directed to a web page shown in FIG. 4. Referring to FIG. 4, user 30 is presented with three products of trousers, namely 50A, 50B and 50C with an option to indicate his liking of one of the three products, an option 52 to buy one of those products and an option 54 to indicate that he has no interest in any of those products. If user 30 clicks on product 50B to indicate his liking thereof, user 30 is directed to another web page of Fashinating shown in FIG. 5.

Referring to FIG. 5, user 30 is presented with three new products of trousers, namely 50AA, 50BB and 50CC with an option to indicate his liking of one of the three products, an option 52 to buy one of those products and an option 54 to indicate that he has no interest in any of those products. User may exercise any of the options as described above until he chooses an item that is based on his liking and taste or abandons the process. At the end of the process his likings from this session are stored in database 32 for future use.

Referring now back to FIG. 3, if user 30 clicks on connecting link 36 (shown in FIG. 2) to view all products offered in the website he is presented with three different products, namely sunglasses 51, sunglasses 53 and a shirt 55 with an option to indicate his liking of one of the three products, an option 57 to buy one of those products and an option 59 to indicate that he has no interest in any of those products. Like in the process previously described in FIGS. 4 and 5, if user 30 clicks on one of any of sunglasses 51, sunglasses 53 or shirt 55 to indicate his liking thereof, user 30 is directed to another web page of Fashinating to be presented with additional products to make further selections. Still referring to FIG. 3, user 30 may elect option 57 to buy one of the products and be directed to a page associated with the consummation of the purchase or option 59 to indicate that he has no interest in any of the three products so that he can be directed to another web page where he will be presented with three new products.

The location of the buttons in the webpage depicted in the drawings may vary without affecting the spirit of the invention. For example the button used to indicate the user's lack of interest in any selection may be placed at the bottom of the page. Further, the activation (clicking) of the buttons may be effected by various well known techniques through the use of the mouse.

The buttons used for expressing liking or lack of interest in a product may be presented in different forms. For example, the liking button may be presented as “more of this style,” “I like it,” or similar terms of approval or liking. The buttons expressing lack of interest may be presented as “not my style,” “more,” “not like,” “dislike,” “more,” “more Fashinating,” or similar terms of expressing lack of interest in an item or items.

In an alternative embodiment of the present invention, a user is not presented with an option to buy an item as the fifth option described above, but as an option to buy after the user indicates his preference or liking of a particular product through options one two or three above or through a list of favorites of products displayed on another page or one of the pages described above.

In an alternative embodiment of the present invention, an option is added in the selection process wherein the user is given the option to identify a favorite brand. This option is added at the start of the selection process or at a point thereafter. The identification of the favorite brand by the user, is used in accordance of the present invention to make suggestions to the user of products of the same or similar brands.

This method and system may be used in many similar business transactions involving selection of products based on a consumer's taste. The method and process is not limited in the number of options presented and described above but includes variations thereof in the numbers of choices presented to the user and the options available. For example, the user may be offered two or more than three products of the product category each time he is presented with product choices as the search advances. Further, he may be presented with the option of liking more than one product of the product category or expressing lack of interest in only some but not all of the products of the product category presented on a page.

In each case, the user's choices are taken into consideration by the method and system of the present invention in determining what new products of the product category are presented to the user in subsequent pages. Other factors such as the choices of people belonging to a similar group of purchasers determined by age, geographic location, and the like, the characteristics and traits of the product like brand, color, etc. or other suggestion criteria are also taken into consideration.

Still further, the system and method may be used not only as described above to make selections of products from different vendors and to be directed to the vendor's website to purchase the product therein but in connection with an online store where the vendor of all or the majority of the products is the owner of the website utilizing the system and method of the present invention.

The above description is of preferred exemplary embodiment of the present invention, and the invention is not limited to the specific forms shown. Modifications may be made in the design and arrangement of the elements within the scope of the invention, as expressed in the claims.

What is claimed is:

1. A method for selecting an item online by a user, comprising the steps of:
first presenting the user with more than one proposed items for selection;
first providing to the user the option to indicate his preference of at least one of the items presented or the option to indicate his lack of interest in all items presented.

2. The method of claim 1 further including the step of giving the user the option to identify the category of items that he is interested in prior to first presenting the user with more than one proposed items for selection.

3. The method of claim 1 further including the step of giving the user the option to view all products available for selecting prior to first presenting the user with more than one proposed items for selection.

4. The method of claim 1 further including the step of giving the user the option of buying one of the items presented.

5. The method of claim 1 further including the step of buying one of the items presented.

6. The method of claim 1 further including the step of indicating the lack of interest in all items presented.

7. The method of claim 6 further including the step of considering the lack of interest indicated in the step of indicating the lack of interest in all items presented.

8. The method of claim 6 further including the step of storing the user's lack of interest in all items presented.

9. The method of claim 1 further including the step of indicating the preference of at least one of the items presented.

10. The method of claim 9 further including the step of considering the preference indicated in the step of indicating the preference of at least one of the items presented.

11. The method of claim 9 further including the step of storing the user's preference of at least one of the items presented.

12. The method of claim 6 further including the steps of:
second presenting the user with more than one proposed items for selection;
second providing to the user the option to indicate his preference of at least one of the items presented or the option to indicate his lack of interest in all items presented.

13. The method of claim 12 further including the step of giving the user the option of buying one of the items presented.

14. The method of claim 12 further including the step of considering the lack of interest indicated in the step of indicating the lack of interest in all items presented.

15. The method of claim 9 further including the steps of:
second presenting the user with more than one proposed items for selection;
second providing to the user the option to indicate his preference of at least one of the items presented or the option to indicate his lack of interest in all items presented.

16. The method of claim 15 further including the step of giving the user the option of buying one of the items presented.

17. The method of claim 15 further including the step of considering the preference indicated in the step of indicating the preference of at least one of the items presented prior to the step of second presenting the user with more than one proposed items for selection.

18. The method of claim 1 further including the step of retrieving information about the user previously stored prior to the step of first presenting the user with more than one proposed items for selection and considering the information so retrieved in determining what items are proposed for selection in the step of first presenting the user with more than one proposed items for selection.

19. The method of claim 1 further including the step of considering other factors prior to the step of first presenting the user with more than one proposed items for selection and considering the factors so considered in determining what items are proposed for selection in the step of first presenting the user with more than one proposed items for selection.

20. A computerized system for selecting an item online by a user, comprising:
a database containing the items that are available for selection;
means for offering more than one item from the database;
means for expressing the user's preference for at least one of the offered items or lack of interest of the offered items;
means for directing the user to the purchase of one of the offered item; and
means for transmitting the users preference or lack of interest in any of the offered items to the database.
